(19) United States
(12) Patent Application Publication
(10) Pub. No.: US 2008/0010183 A1
(43) Pub. Date: Jan. 10, 2008

(54) Electronic trading system

(76) Inventors: Simon Marcus Ashworth Holmes, (US); Kieron Michael Nolan, (US); Phillip Haynes, (US)

Correspondence Address: CROWELL & MORING LLP;INTELLECTUAL PROPERTY GROUP, P.O. BOX 14300, WASHINGTON, DC, 20044-4300, US

(21) Appl. No.: 11/402,465

(22) Filed: Apr. 12, 2006

(51) Int. Cl. G06Q 40/00

(52) U.S. Cl. 705/37

(57) ABSTRACT

An electronic trading system is described in which risk premiums are stored for each participant in respect of other participants. These risk premiums are added or otherwise applied to the prices on orders, for the purposes of matching orders to make trades and for providing market data to participants. The risk premiums allow each participant to account for the risk associated with trades with particular other participants.

### FIELD OF THE INVENTION

The present invention relates to electronic trading systems and methods.

### BACKGROUND OF THE INVENTION

Electronic trading systems which accept orders such as bids and offers, or other specified requests of participants, in order to facilitate trades between participants, are widely disclosed in the prior art. Some systems provide a participant with information about existing orders and enable the participant to request a trade, while other systems automatically form a trade from two or more orders when they are found to match. However, to provide an anonymous market in which counterparties are unaware of each other's identities until a trade has been completed, participants are generally provided with a less than complete view of the market.

Market participants, such as financial institutions, generally wish to control the various risks inherent in trading. Such risks may include the risk that a counterparty will default before settlement or completion of a trade, or that a counterparty will default on a contract which extends for some time after completion of a trade. One way to control settlement risk is to provide a central counterparty (CPP) which guarantees settlement or completion of all arranged trades.

The central counterparty model is frequently organised as an insurance scheme. Participants contribute a premium to the CPP and this aggregate guarantee fund is used to cover any failures by market participants, for example by providing settlement cash or by buying securities to cover a failure. This model is quite common and has proven to be a way of providing market stability. However, the model has several drawbacks. The excess capital committed to the guarantee fund represents an opportunity loss if there are less failures than expected, and because it is based on an insurance model, participants have to accept the actuarial evaluation of their premiums by the CPP. Furthermore, a practical implementation generally requires much infrastructure, which makes it unattractive for small, new or emergent markets, or where the nature of the market makes the necessary premium too high for participants.

### BRIEF SUMMARY OF THE INVENTION

The invention provides electronic trading systems and methods in which adjustments to order prices, and the consequent amount of monetary settlement in a trade, are automatically made to include premiums associated with the risk of trading with a particular party. To this end, each participant in the market facilitated by the system is permitted to define, or has defined on their behalf, a plurality of different risk premiums to be added or otherwise used in the case of trading with different counterparties. Different risk premiums may also, or instead, be defined for a particular participant for trading different types or classes of tradable asset.

The invention is particularly applied to the trading of financial instruments such as interest rate securities, in which case it may be combined with other credit control arrangements such as limited lines of credit consumed by trades, and different risk premiums may be used depending on the inherent or perceived risk of different instruments, for example based on duration or volatility. A participant may be permitted to manually define a set of risk premiums, but according to some aspects of the invention risk premiums for different instruments are calculated or adjusted automatically on the basis of risk factors already defined by or on behalf of a participant.

Financial instruments for trading may include strategy instruments which combine two or more component instruments, and the trading system may be adapted to generate implied instruments from outstanding orders submitted by the participants, to increase market flexibility, for example as discussed in U.S. Ser. No. 11/212,465, which is herein incorporated by reference for all purposes. In this case, the price of an implied instrument may be adjusted using risk premiums relating to the participants which submitted any or all component orders, such as a maximum risk premium taken from this group.

In particular the invention provides a method of operating an electronic trading system to facilitate trading between a plurality of participants, comprising:

for each participant, storing one or more risk premiums relating to others of the participants;

receiving orders from market participants;

combining said orders with said risk premiums.

Preferably, each order is associated with an order price, and combining an order with a risk premium comprises adding said risk premium to the price associated with said order.

The invention also provides a method of operating an electronic trading system to allow market participants to submit orders and to receive market data relating to orders submitted by other participants, comprising generating said market data using said orders,

wherein the step of generating includes applying risk premiums to said orders.

The invention also provides a method of operating an electronic trading system to allow market participants to submit orders for combining with other orders submitted by participants to complete trades, comprising:

applying risk premiums to said orders to form risk adjusted orders; and

seeking matches between said risk adjusted orders.

The invention also provides apparatus for putting the methods of the invention into effect, including for example a centralised market server where risk premium data is held and applied to order and trade data, and a plurality of client nodes which receive data adjusted using the risk premiums. In this way an anonymous market can be maintained. However, certain anti-gaming mechanisms may be required in order to prevent participants from deriving information regarding which participants are responsible for which orders or aspects of the current market state. For example, it maybe necessary to limit or turn off the application of risk premiums in generating market data to be provided to a participant which has very recently changed their own risk premiums, or if the risk premiums do not satisfy diversity criteria.

In particular, the invention provides an electronic trading system comprising:

a market server adapted to receive orders submitted by market participants for trading with orders submitted by other participants,

the market server being further adapted to store, for each participant, one or more risk premiums relating to others of the participants, and to combine said orders with said risk premiums.

The invention also provides one or more computer program code operable to put the above methods into effect, or to bring into effect apparatus according to the invention when executed on suitable computer equipment. The invention also provides computer readable media carrying such computer program code.

### BRIEF DESCRIPTION OF SEVERAL VIEWS OF THE DRAWINGS

Embodiments of the invention will now be described, by way of example only, and with reference to the accompanying drawings of which:

FIG. 1 illustrates a market server forming part of an electronic trading system in which risk premiums are applied to provide participants with the means to manage trading risk; and

FIG. 2 illustrates a more detailed implementation of such an electronic trading system.

### DETAILED DESCRIPTION OF THE INVENTION

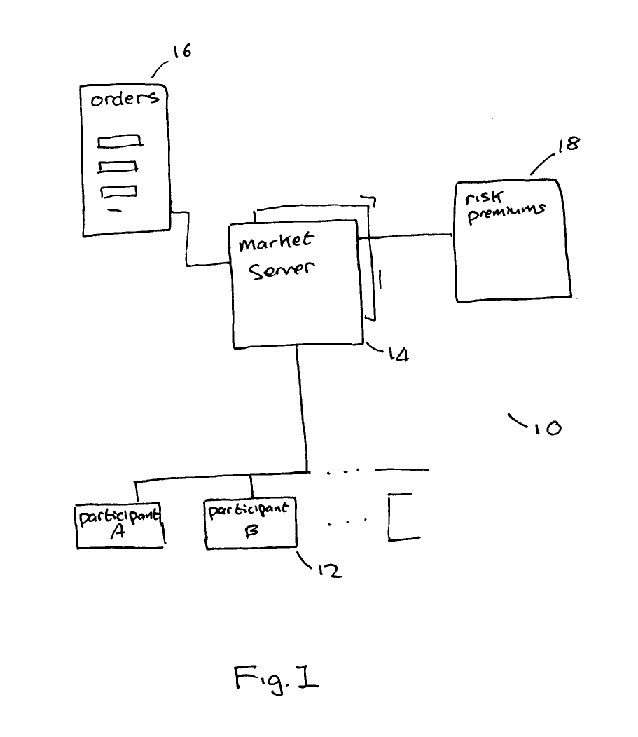

Referring first to FIG. 1 there is illustrated, in a schematic form, an electronic trading system 10. A number of participants 12, denoted A,B . . . are able to trade with each other by submitting orders to a market server 14. Participants may be individuals, banks, or other entities. The orders are stored in an order book 16, in one or more memory elements which may be collocated or distributed in various ways. The market server 14 derives market data from the order book and makes this data available to the participants. This market data may contain express details about some or all of the orders, and may contain more generic information derived from groups of orders. The market server 14 also establishes trades which result from matching orders submitted by different participants. This may occur through automatic matching of already submitted orders, by participants requesting trade on an existing order, and other schemes. From the perspective of a particular participant, other participants with which trades are arranged or might be arranged are referred to as counterparties.

The system may facilitate trade in financial instruments, such as interest rate swaps or currency forwards, but can be used to trade any other suitable product. The market may be anonymous, in the sense that participants do not know the identity of the participant which submitted a particular order or which is responsible for a particular market price or other information contained within the market data.

The market server 14 is adapted to apply premiums 18 to orders and trades. These may be referred to as risk premiums, and denote a supplement to an order to permit a participant to allow for risk associated with a trade incorporating that order. The premium may be applied to the price associated with an order, and can then be referred to as a price premium, allowing a participant to include a monetary margin to reflect a risk associated with trading on an order. To this end, a participant may be permitted to define different premiums for a variety of circumstances, including different premiums for different potential or actual counterparties, for different entities or instruments to be traded, and so on.

Each participant will typically use a number of computer terminals to carry on trading activities. These terminals will typically communicate, over a data network, with one or more market server computers, where the premiums and order book are stored. To maintain an anonymous market in which participants do not know which other participant is responsible for a particular aspect of the market such as a currently available order, it is preferable for the premiums to be applied to order data at the market server. Of course, the functionality of the market server may be distributed across a number of computer entities.

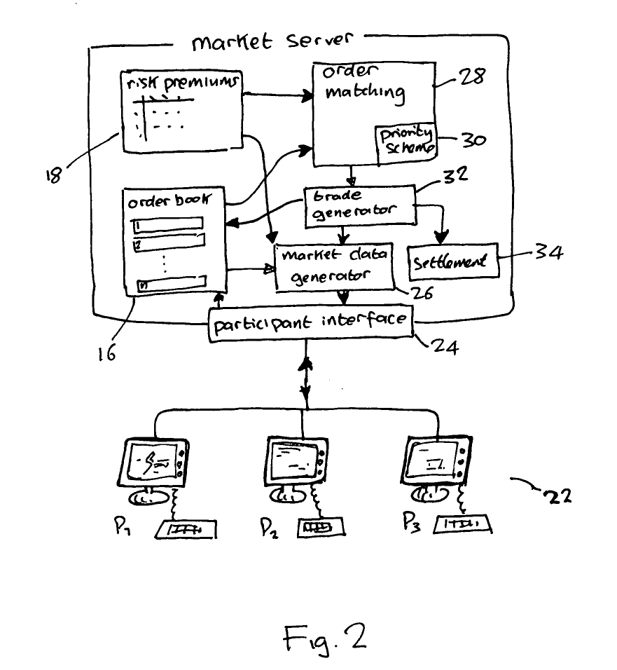

FIG. 2 illustrates a more detailed embodiment of the invention applied to the trading of financial instruments. Each instrument has a buy and sell side, such as the buy and sell sides of an interest rate swap. A participant can submit an order either to buy, or to sell a specified quantity of a particular financial instrument, at a specified price. A large number of different instruments may be available for trade in the system, for example including spreads and other strategy instruments.

The participants 12 communicate with a market server computer 14 using a plurality of client node computers 22, through a participant interface 24. Orders submitted by participants are stored in an order book 16 in the market server. Risk premiums 18 are also stored in the market server. A market data generator function 26 applies the risk premiums to the orders in the order book to generate market data which is forwarded to the participants through the interface 24.

An order matching function 28 seeks matches between orders in the order book, and if found, passes the matching orders to a trade generator function for completing a trade. The order matching function 28 applies the risk premiums to the orders when seeking price matches between orders, and also applies a priority scheme 30 to determine which of several matching orders should be traded first, for example according to time of submission of orders, size of orders or risk premiums applied to orders.

The trade generator function 32 passes information regarding trades to the market data generator for communication to participants. The order book 16 is adjusted according to trades completed, for example by deleting traded orders. Information regarding completed trades is passed to a settlement function 34 for settlement and further processing.

In the present embodiment, each participant is able to define at least one risk premium for applying to potential trades with each other participant. The risk premiums defined for or by a first participant define adjustments to be made to the price associated with an order submitted by the first participant, when that order is used to generate market data for use or viewing by a second participant, or when that order is to be used in order matching to make a trade with the second participant. The risk premiums defined for, on behalf of, or by the first participant also define adjustments to be made to the price associated with an order submitted by a second participant, when that order is used to generate market data for use or viewing by the first participants or when that order is to be used in order matching to make a trade which the first participant.

Each premium may be zero or undefined, as well as a positive or negative adjustment to price. A positive premium represents a premium which must be paid on an order to facilitate a trade, whereas a negative premium might be used to discount sell prices or enhance buy prices to improve trade with a particular participant.

For simplicity we will assume here a single risk premium for both buy and sell sides, and for all instruments. Vectors of risk premiums for two participants, Cᵢ and Cⱼ, out of a total of n participants may then be written as follows:
Δᵢ={δᵢ₁,δᵢ₂,δᵢ₃, . . . , δᵢₖ, . . . , δᵢ₍ₙ₋₁₎,δᵢₙ}
Δⱼ={δⱼ₁,δⱼ₂,δⱼ₃, . . . , δⱼₖ, . . . , δⱼ₍ₙ₋₁₎,δⱼₙ}

We can construct two prices Pₚ and Pₜ where P_{p(x,y)} is the “presentation” price of an order at price P entered by participant x as presented to participant y, and Pₜ is the “trade” price for any two orders.

Consider the following scenario, where “B:” denotes a “buy” price:
Cᵢ enters an order O₀ to buy at P₀
B:P_{0p(i,j)}=P₀+δᵢⱼ+δⱼᵢ
P₀ₜ=B:P₀+δᵢⱼ

So the price of order O₀ visible to participant j is the original price of the order plus the sum of the risk premiums between the two participants. So, in order for participant j to be able to trade against this order they have to be willing to trade at P₀+δᵢⱼ+δⱼᵢ. Consider the case where a trade will occur. “S:” denotes a “sell” price:
Cⱼ enters an order O₁ to sell at P₁,

where P₁=P₀+δᵢⱼ+δⱼᵢ
S:P_{1p(j,i)}=P₁−δⱼᵢ−δᵢⱼ
P₁ₜ=S:P₁−δⱼᵢ

A trade occurs if P₀ₜ matches or exceeds P₁ₜ.

It can be seen that in this embodiment the trade price is the original price of an order submitted by a first participant plus the premium defined by that participant for trading with a second participant, and the presentation price is the trade price plus the premium defined by the second participant for trading with the first participant:
Pₜ=P₁+δ_{(1,2)}; and
Pₚ=Pₜ+δ_{(2,1)}

In the arrangement of FIG. 2 the presentation price is generated by the market data generator, and made available to participant client nodes 22, and the trade price is used by the order matching function 28 to test for matching orders. Notably, before a potential trade is completed, neither participant knows which counterparty originated an order that is presented to them. Only once a trade is done is the name of the counterparty given to the other side of the trade. In addition, the trade will occur at the price that a participant is willing to pay plus the risk premium allocated by that participant to the trade counterparty.

In the context of trading parties such as banks or other financial institutions wishing to handle trading risk in a rigorous manner this can be thought of as the price a party wanted in the order that they actually entered plus a “fee” associated with a credit department of the institution for the risk of the deal with the particular counterparty.

The priority scheme 30 typically implements a price-time algorithm in which orders are first matched on price, and if more than one pair of orders matches on price, orders submitted earlier in time are first used to complete trades. However, in some embodiments a price-risk-time algorithm may be used in which orders matching on price are ordered for trading according to risk premiums associated with the orders, and only then according to time of order submission, if necessary. If orders having higher associated risk premiums are used first, then this will have the effect of removing risk from the market at an increased rate. Conversely, if orders having lower associated risk premiums are used first to make trades, then this will have the effect of lowering settlement risk, at least according to the risk represented by the risk premiums defined by the participants. Either scheme may be desirable for these and other reasons, and other metrics based on the order risk premiums may be used.

By way of example, two or more pairs or other groups of orders each matched on price can be further ordered in priority for trading according to risk premiums by summing together the risk premiums associated with a potential trade. In the notation used above, this sum R may then be written by R=δᵢⱼ+δⱼᵢ. Other functions of the risk premiums could be used, for example R=max(δᵢⱼ,δⱼᵢ), or in general taking account of other possible parameters denoted by the ellipsis, R=R(δᵢⱼ,δⱼᵢ, . . . ), and potential trades ordered for trading according to increasing or decreasing R. If potential trades are ordered for trading on the basis of risk premiums, they may still be ordered on the basis of time of submission of the component orders, but typically only if two potential trades match on the basis of both pricing and risk premiums. The time of submission used will typically be the time of submission of the last order required to cause a price match within a group of orders to form a potential trade, although other functions of times of submission could also be used.

In the embodiment illustrated in FIG. 2, when the trade generator function completes a trade, details of the trade are both passed to the settlement function 34 and to the market data generator 26 for reporting to the participants. For a participant not involved in the trade the price of the trade is shown as if the participant was on either side of the trade, therefore requiring two prices to be provided. Thus when a price match occurs between a buy and a sell order such that Pₜ₁=Pₜ₀, the prices observable to a viewing participant x would be B:P_{0p(i,x)} and S:P_{1p(j,x)}. To maintain anonymity of the completed trade, trade prices P_{t(i,x)} and P_{t(j,x)} should not be shown to participants not party to the trade, as these prices may allow participants to infer the identities of the parties to the trade, at least in some circumstances.

The detailed discussions above presume each trade is formed of two matching orders, for example on the buy and sell side of a single financial instrument. “Strategy” financial instruments have more sides, and hence usually more than two parties. Strategy instruments include spreads which link two instruments, and more complex strategy instruments such as butterflies. When strategy instruments are available for trade, the possibility arises of generating a fictitious “implied” order linking two or more real orders submitted by participants. A matching real order then effectively trades with all of the real orders making up the implied order. An implied order can itself be partly or completely formed from other implied orders.

Using implied orders generally leads to increased market flexibility and increases the number of trades which can be matched out of a particular order book. Implied orders are discussed in detail in U.S. patent application Ser. No. 11/212,465 entitled “Order matching in electronic trading systems” filed on 25 Aug. 2005, which is hereby incorporated by reference.

As discussed in this earlier application, it is acceptable to imply from the best price in the source orderbook. This follows from the supposition that there is such a thing as a “best price” and that this is true for all users. However, when prices can be graded to take into account credit worthiness the best price for one observer may not be the best price to another observer. Therefore the best implied price in a destination orderbook may be derived from a price that is not at the best level in the source orderbook. With that in mind, the risk premium scheme discussed above for real orders can also be used for implied orders.

When creating an implied price from a chain of orders the risk premiums of both participants are used at each point where the chain is extended by adding a new spread. These points represent trades, should the implied price be traded, and the participants to each potential trade must have their risk premiums satisfied. In practice this means that unless the risk premiums are small compared to the bid/offer spread the implied orders will not be competitive with real orders. In the most simple implied chain a real order in a single instrument combines with a spread order, one leg of which satisfies the single instrument order. This creates an implied order in the other leg of the spread:

O₁: P₁ Buy S_{b}

O₂: P₂ Sell S_{ab}

O₃ᵢ: Buy Sₐ

Real Order 1 (from Firm 1): Buy B

Real Order 2 (from firm 2): Sell (AB)

Implied order 3: Buy A

Should a third firm sell Sₐ by entering the following order:

O₄: P₃ Sell Sₐ

Real Order 4 (from firm 3): Sell A

then, subject to price and credit, trades will be generated in Sₐ (between P₂ and P₃) and S_{b} (between P₁ and P₂). These trades must be at prices that satisfy these firms' risk premium requirements. Therefore if the real order prices are:

O₁: 100

O₂: 10

O₄: 90

then trades can be generated at the following prices:

T₁: P₁ buys S_{b}@100 from P₂

T₂: P₂ buys Sₐ@90 from P₃

However, if the firms have risk premiums with each other then these must be satisfied as well. If P₁ requires a premium of 1 when dealing with P₂ then T₁ must occur at a price no higher than 99. If P₂ requires a premium of 1 when dealing with P₁ then O₂ must be executed at 11. This means that with T₁ at 99, if P₃ has a zero premium with P₂ then T2 must be at 88. Therefore the implied price presented to P₃ on 0₃, pᵢ must be 88, which can be expressed as the “natural” unadjusted price of the two orders (100-10, or 90) adjusted by the sum of the risk premiums of the two firms with respect to each other.

To generalise this statement;
pₖ=Oᵢ−Oⱼ+δ_{i,j},δ_{j,i}

Therefore a chain of implied orders will provide a price for the last leg, pₙ, which is:
pₙ=f(O₁,O₂, . . . , Oₖ, . . . , Oₙ)−f(δ_{1,2}, . . . , δ_{i,j},δ_{j,i}, . . . , δ_{n-1,n},δ_{n,n-1})

where the function (f) is a combination of addition and subtraction of the various factors depending on the specific orders involved in the chain.

The risk premiums discussed in connection with FIG. 2 were simplified to a single risk premium for each different pair of participants. As already discussed, different risk premiums may be defined based on more factors, such as for both the buy and sell side of a financial instrument, and for different financial instruments. Thus:
δ_{xy}=f(side:{buy,sell}, counterparty:{C₀,C₁ . . . Cₙ}, instrument:{I₁,I₂, . . . Iₙ})

where the instrument element denotes particular individual, classes, groups or subsets of financial instruments.

When a strategy order is traded with a single counterparty the two or more component trades that ensue will to some extent offset each other. In many financial markets the trades will be subject to a contract that allows the future cashflows of these trades to be netted, and the risk on the two component trades is therefore lower than if they had been executed with two different counterparties. Therefore, while it is appropriate to charge a risk premium on each leg of a strategy when the trades are with two or more counterparties, it is desirable to have the option to offset risk premiums for two or more trades with a single counterparty. Taking the example of a strategy order involving the sale of a five-year swap and simultaneous purchase of a ten-year swap, when traded with a single counterparty the actual default risk is on a trade of five years tenor that starts in five years time. The risk premium for this is likely to be significantly lower than that of the five and ten year trades aggregated. Of course, this netting of risk and subsequent reduction of risk premium can also happen at intervals throughout the trading day, crediting back premium already charged on deals that were not executed simultaneously but which now form nettable sets.

A variety of ways of managing trading risk using a credit limit infrastructure in an electronic trading system are described in U.S. patent application Ser. Nos. 11/212,458, 11/212,463, and 11/212,464, each entitled Counterparty Credit in Electronic Trading Systems and filed on 25 Aug. 2005, each of which is hereby incorporated herein by reference. Particular aspects include the allocation of credit to tranches which represent different durations or terms of an instrument such as an interest rate swap, although such tranches can also be used to represent volatility bands or categories of other measures of risk. Risk premiums may be separately defined for different tranches. If such a scheme is used instead of defining premiums for separate instruments or instrument classes then the setting and managing of risk premiums by participants may be considerably simplified.

Risk premiums as discussed above may be entered selectively, in blocks or by way of defaults for or by participants, but they may also be calculated automatically by the trading system, for example at a client node or a market server. The above mentioned U.S. patent applications discuss various ways of assessing the degree to which a particular trade or order consumes established lines or tranches of credit. A trade of an instrument with a perceived higher inherent risk, for example an interest rate swap of long duration, will generally consume more credit than one of a lower risk, for example an interest rate swap of shorter duration. The correspondence between an order or trade, and the associated credit to be consumed by the trade, can be achieved, for example, using a duration ratio of loan equivalence scheme. Participants may be permitted to enter their own parameters or risk factors to control such a scheme. In the present invention, risk premiums may be calculated automatically using such loan equivalence or other risk factors.

Risk factors may be calculated more accurately using the cost of purchasing credit derivatives on the loan equivalent quantity of a trade, instead of its notional principal. This allows a single risk parameter to be defined for each credit tranche or other risk grouping, which is combined with a participant's risk factors such as loan equivalence factors to calculate risk premiums for each instrument.

As discussed above, the present invention may be applied to an anonymous market in which participants are unable to gain information regarding the identity of other participants responsible for existing orders or other aspects of market state. However, by careful setting or adjustment of risk premiums relating to particular other participants, a participant may be able to obtain or derive such information. For example, setting a single large risk premium for a particular counterparty may make orders submitted by that counterparty stand out by their deviation from the rest of the market. Changing a single risk premium and watching for the effect on the market state information available, or setting risk premiums for a limited subset of participants, may provide similar information.

To prevent such “gaming” activity intended to break the anonymity of the market, embodiments of the invention limit the market data available to a participant under certain circumstances. In particular, market data available to a participant is limited immediately after a change to their risk premiums, except where all risk premiums are adjusted to zero. The duration of this limitation may depend on the type of market. Market data is also limited if a participant has insufficient risk premiums set.

The market data may be limited by excluding all risk premium information from the available market data and data relating to completed trades. Instead, only the true prices of orders and trades is provided. Exclusion of risk premium adjustments may make these prices unrealistic, so a flag is provided to indicate the temporary limitation, for example as a graphical indicator such as a character or colour on a market data display screen.

An example of gaming activity is as follows. A party sets risk premiums to zero for all counterparties and then, while observing a single order in the market, sets one risk premium to a high enough level to produce a price shift that is significantly greater than normal moment-to-moment volatility. If the price of the observed order moves at the moment by approximately the adjusted risk premium, the observer can be almost certain that the order is owned by the counterparty whose risk premium was adjusted.

An example of an anti-gaming function that defeats or at least suppresses this gaming activity is as follows. Risk premiums that significantly exceed moment-to-moment price volatility can help reveal counterparty identity. This volatility is measured and used to create a parameter Q that is an appropriate multiple of that volatility. The number of risk premiums entered by a party that are in excess of Q is measured and referred to as L. For smaller values of L it is easier to guess the identity of a counterparty when a significantly poor price is seen in the market. We define a parameter X as the appropriate minimum number of parties that could be behind an order such that it is still hard to guess the identity of a counterparty. For example, in a market with 40 participants, X might be 10 or 20.

If L<X then the application of risk premiums will make it too easy to guess the identity behind an order, so the observer will only be shown the raw prices with no risk premiums applied. Trades will still be done at the trade price Pt.

This functionality provides an example of a function L of the risk premiums defined for a party, and an anti-gaming threshold X, whereby if the value of the function falls below the threshold then the application of risk premiums to orders is restricted or suspended altogether when generating market data for a participant.

As well as requiring defense against gaming activity, adjustments to the set of risk premiums will require updating of the market data provided to participants, and will require updating of the order book if this includes order data incorporating premium risks.

The system may be adapted to provide limited market data, excluding risk premium contributions, to participants, for example on request. Participants can then view the market in a “raw” state free from the effects of risk premiums. The provision of such “raw” market data will also generally require some anti-gaming measures to be put into place.

The following is an example of calculating the presentation prices and the trade price for two participants Cᵢ and Cⱼ and orders O₀ and O₁. For the purposes of this example we have excluded the instrument factor from the risk premium vector to simplify the example:

Cᵢ has a risk premium vector of Δᵢ={δᵢᵢ=0, δᵢⱼ={1,1}}.

Cⱼ has a risk premium vector of Δⱼ={δⱼᵢ={2,2}, δⱼⱼ=0}.
Cᵢ enters an order O₀ to buy at a price of 60
B:P_{0p(i,j)}=P₀+δᵢⱼ+δⱼᵢ
B:P_{0p(i,j)}=60+1+2
B:P_{0p(i,j)}=63 and;
   P_{0t(i,j)}=P₀+δᵢⱼ
   P_{0t(i,j)}=60+2
   P_{0t(i,j)}=62

Cⱼ sees a buy order at a price of 63. Cⱼ is willing to sell at this price and so enters an order O₁ at a price of 63:
S:P_{1p(j,i)}=P₁−δⱼᵢδᵢⱼ
S:P_{1p(j,i)}=63−1−2
S:P_{1p(j,i)}=60 and;
   P_{1t(j,i)}=P₁−δⱼᵢ
   P_{1t(j,i)}=63−1
   P_{1t(j,i)}=62

As a result there is a trade to be executed at a price of 62. Net to Cᵢ the trade price is Pₜ−δᵢⱼ (60), their original order price and net to Cⱼ the trade price is Pₜ+δⱼᵢ (63) the price at which Cⱼ was willing to trade. So each party got the price they wanted and their credit departments got the premium they required for the counterparties involved in the trade.

What is claimed is:

1. A method of operating an electronic trading system to facilitate trading between a plurality of participants, comprising:
for each participant, storing one or more risk premiums relating to others of the participants;
receiving orders from market participants;
combining said orders with said risk premiums.

2. The method of claim 1 wherein each order is associated with an order price, and combining an order with a risk premium comprises adjusting the price associated with said order using said risk premium.

3. The method of claim 1 wherein the step of combining comprises:
combining the price associated with an order with:
a risk premium set for a first participant which submitted the order in respect of a second participant; and
a risk premium set for the second participant in respect of the first participant, and
providing the combined price to the second participant.

4. The method of claim 1 wherein the step of combining comprises:
forming combined prices by combining the price associated with each of a plurality of orders each with a corresponding risk premium set for a second participant in respect of a first participant which submitted the order;
finding matching prices between two of said combined prices; and
completing a trade using the orders having said matching prices.

5. The method of claim 4 wherein, if more than one grouping of orders matches on the basis of price, the price matched orders are used to complete trades in an order according to a function of the risk premiums associated with the price matched orders.

6. The method of claim 5 wherein, if more than one grouping of orders matches on the basis of price, and according to the function of the risk premiums, then the matching orders are used to complete trades in an order according to the times at which the orders were submitted by the participants.

7. The method of claim 1 wherein the trading system facilitates trading of financial instruments, and, for each participant, separate risk premiums are defined for different classifications of said financial instruments.

8. The method of claim 7 wherein said instrument classifications comprise classifications according to duration of an instrument.

9. The method of claim 7 wherein, for a participant, separate risk premiums are automatically calculated for different instrument classifications according to risk factors defined for that participant.

10. The method of claim 7 wherein said financial instruments comprise strategy instruments combining a plurality of component financial instruments, the method comprising creating implied strategy orders linking existing orders submitted by participants.

11. The method of claim 10 wherein combining an order for an implied strategy instrument with a risk premium comprises combining the order with one or more risk premiums defined for participants which submitted the existing orders.

12. A method of operating an electronic trading system to allow market participants to submit orders and to receive market data relating to orders submitted by other participants, comprising generating said market data using said orders,
wherein the step of generating includes applying risk premiums to said orders.

13. The method of claim 12 further comprising receiving one or more risk premiums for each of said participants, each risk premium defining a premium for generating market data for use by said each participant on the basis of orders submitted by others of said participants.

14. The method of claim 13 wherein each order comprises a price and each risk premium defines an adjustment to be applied to the price of orders to which the risk premium relates.

15. The method of claim 14 wherein market data for a first participant is generated using an order submitted by a second participant, and the step of generating comprises applying to said order an appropriate risk premium defined for said first participant in respect of said second participant, and an appropriate risk premium defined for said second participant in respect of said first participant.

16. The method of claim 12 further comprising providing, to each participant, the market data generated using risk premiums for said participant.

17. The method of claim 16 comprising storing said risk premiums and carrying out said step of generating at a market server, and providing said market data to a plurality of client nodes distant from said server.

18. The method of claim 16 wherein said market data provided to each participant includes data representing orders submitted by other participants.

19. The method of claim 12 comprising restricting the application of said risk premiums to said orders when generating market data for a participant, for a limited time period.

20. The method of claim 19 wherein the application of said risk premiums to said orders is restricted for a limited time period after alteration of risk premiums for the participant.

21. The method of claim 12 comprising restricting the application of said risk premiums to said orders when generating market data for a participant, if a function of the risk premiums defined for the participant falls below an anti-gaming threshold.

22. The method of claim 12 wherein said orders are orders for trading financial instruments.

23. The method of claim 22 wherein each order defines at least a financial instrument, a price and a submitting participant.

24. A method of operating an electronic trading system to allow market participants to submit orders for combining with other orders submitted by participants to complete trades, comprising:
applying risk premiums to said orders to form risk adjusted orders; and
seeking matches between said risk adjusted orders.

25. The method of claim 24 further comprising storing one or more risk premiums for each participant, each risk premium defining a premium for applying to an order submitted by a specified other of said participants when seeking a match with an order submitted by said each participant.

26. The method of claim 25 wherein each order comprises a price and each risk premium defines an adjustment to be applied to the price of orders to which the risk premium relates.

27. A method of operating an electronic trading system to combine orders submitted by market participants to complete trades, each order being associated with at least a price and one or more risk premiums, wherein orders matching on price are ordered for trading dependent on the associated one or more risk premiums.

28. The method of claim 27 wherein orders matching on price are ordered for trading dependent on associated times of submission of the orders by the participants, after ordering dependent on the associated one or more risk premiums.

29. An electronic trading system comprising:
a market server adapted to receive orders submitted by market participants for trading with orders submitted by other participants,
the market server being further adapted to store, for each participant, one or more risk premiums relating to others of the participants, and to combine said orders with said risk premiums.

30. The system of claim 29 further comprising an order matching engine adapted to seek matches between orders combined with said risk premiums.

31. The system of claim 30 wherein, if more than one grouping of orders matches on the basis of price, the price matched orders are used to complete trades in an order based on the risk premiums associated with each grouping of orders.

32. The system of claim 31 wherein, if more than one grouping of orders matches on the basis of price and on the basis of risk premiums, then the matching orders are further ordered for trading according to times of submission of the orders by the participants.

33. The system of claim 29 further comprising a market data generator adapted to generate, for each participant, market data derived from said orders combined with said risk premiums.

34. The system of claim 33 wherein supply of market data to participants is selectively restricted using an anti-gaming function dependent upon the setting of the risk premiums.

35. The system of claim 29 adapted for the trading of financial instruments, wherein the orders are orders for trading selected ones of said financial instruments.

36. An electronic trading system in which participants submit orders for trades and receive market data derived from orders submitted by other participants, comprising:
a market server adapted to receive and store said orders; and
a plurality of client nodes adapted to receive said market data,
wherein said market server is further adapted to store, for each participant, risk premiums relating to other participants, and to generate market data for use by the each participant by applying the relevant risk premiums to orders submitted by other participants.

37. An electronic market in which participants submit to the market risk premiums for potential counter participants, the market being adapted to apply the risk premiums to trades created within the system.
